(19) United States
(12) Patent Application Publication
(10) Pub. No.: US 2011/0298427 A1
(43) Pub. Date: Dec. 8, 2011

(54) BATTERY HEATING APPARATUS FOR VEHICLE

(75) Inventors: Takuro UEMURA, Wako-shi (JP); Mitsuaki HIRAKAWA, Wako-shi (JP); Satoshi HASHINO, Wako-shi (JP)

(73) Assignee: HONDA MOTOR CO., LTD., Tokyo (JP)

(21) Appl. No.: 13/150,520

(22) Filed: Jun. 1, 2011

(30) Foreign Application Priority Data
Jun. 4, 2010 (JP) 2010-128540

(51) Int. Cl. H02J 7/14

(52) U.S. Cl. 320/134

(57) ABSTRACT

In an apparatus for heating a battery of a vehicle, having an electric rotating machine and buck-boost converter between the battery and rotating machine to step up/down voltage outputted from the battery to be supplied to the rotating machine and step up/down voltage generated by the rotating machine to be supplied to the battery, it is configured to have a first capacitor interposed between wires connecting the battery to the converter, a second capacitor interposed between wires connecting the converter to the rotating machine, and a heating controller to control operation of the converter to generate current similar to rectangular wave current and input/output the current between the battery and the second capacitor through the first capacitor so as to heat the battery. With this, it becomes possible to efficiently heat the battery so that the battery can output expected power, without adversely affecting the size of the apparatus.

### BACKGROUND OF THE INVENTION

1. Technical Field

This invention relates to a battery heating apparatus for a vehicle.

2. Background Art

In recent years, there is known a vehicle such as an electric vehicle whose wheels are driven by rotational outputs of an on-board electric rotating machine (motor/generator) and such the vehicle is equipped with a battery (secondary battery) for supplying power to the rotating machine. However, when the ambient temperature is relatively low in the winter time or the like, it sometimes causes the decrease in power output of the battery compared to the case of the normal ambient temperature, in other words, it interferes with expected power generation by the battery.

To cope with it, various devices for heating up the battery are proposed conventionally, as taught, for example, by Japanese Laid-Open Patent Application No. 2008-35581 ('581) and International Publication No. WO2002/065628 ('628). In '581, a heater is installed near the battery to heat it up. In '628, a DC/DC converter interposed between the battery and rotating machine is switching-controlled so as to increase ripple current of direct-current power outputted from a capacitor and the ripple current is supplied to the battery, whereby heat generation of internal resistance of the battery is promoted and the battery is heated up accordingly.

### SUMMARY OF INVENTION

However, in the configuration of '581, since the heat is transferred from the outside of the battery, the heating efficiency is low and also the additionally-installed heater results in the increase in size and complexity of the device, unfavorably.

Further, when the configuration to heat the battery using the direct-current power stored in the capacitor is applied as in '628, large capacitance of the capacitor is required and it adversely affects the size of the device. In addition, since it utilizes the ripple current generated upon the switching control, in the case of low-frequency switching, again the large capacitance of the capacitor is required because charge transfer corresponding to voltage fluctuation of the capacitor plays a main role for the heating, whilst in the case of high-frequency switching, amplitude of the ripple current is small and heat generation of internal resistance of the battery is not enough accordingly, so that the effective heating of the battery can not be achieved, disadvantageously.

An object of this invention is therefore to overcome the foregoing drawbacks by providing a battery heating apparatus for a vehicle, which apparatus can efficiently heat a battery so that the battery can output expected power, without adversely affecting the size of the apparatus.

In order to achieve the object, this invention provides an apparatus for heating a battery of a vehicle, having an electric rotating machine installed in the vehicle and a buck-boost converter interposed between the battery and the rotating machine and adapted to step up/down voltage outputted from the battery to be supplied to the rotating machine and step up/down voltage generated by the rotating machine to be supplied to the battery, comprising a first capacitor interposed between a positive electrode wire and a negative electrode wire, the wires connecting the battery to the converter; a second capacitor interposed between a positive electrode wire and a negative electrode wire, the wires connecting the converter to the rotating machine; and a heating controller adapted to control operation of the converter to generate current similar to rectangular wave current and input/output the current between the battery and the second capacitor through the first capacitor so as to heat the battery.

### BRIEF DESCRIPTION OF DRAWINGS

The above and other objects and advantages of the invention will be more apparent from the following description and drawings in which:

FIG. 1 is an overall view schematically showing a battery heating apparatus for a vehicle according to a first embodiment of this invention;

FIG. 2 is a circuit diagram of an equivalent circuit of the battery shown in FIG. 1;

FIG. 3 is a flowchart showing the operation of heating control by an electronic control unit shown in FIG. 1;

FIG. 4 is a graph showing current flowing through constituent components such as the battery during strong-heating control shown in FIG. 3;

FIG. 5 is a graph showing ON/OFF of insulated-gate bipolar transistors of a buck-boost converter during the strong-heating control shown in FIG. 3;

FIG. 6 is a data table of results of simulation for evaluating transition of a battery temperature in heating control shown in FIG. 3;

FIG. 7 is a data table similar to FIG. 6, but showing results of simulation for evaluating transition of the battery temperature in the heating control shown in FIG. 3; and

FIG. 8 is a flowchart similar to FIG. 3, but showing the operation of heating control of an electronic control unit of a battery heating apparatus for a vehicle according to a second embodiment of this invention.

### DESCRIPTION OF EMBODIMENTS

A battery heating apparatus for a vehicle according to embodiments of the present invention will now be explained with reference to the attached drawings.

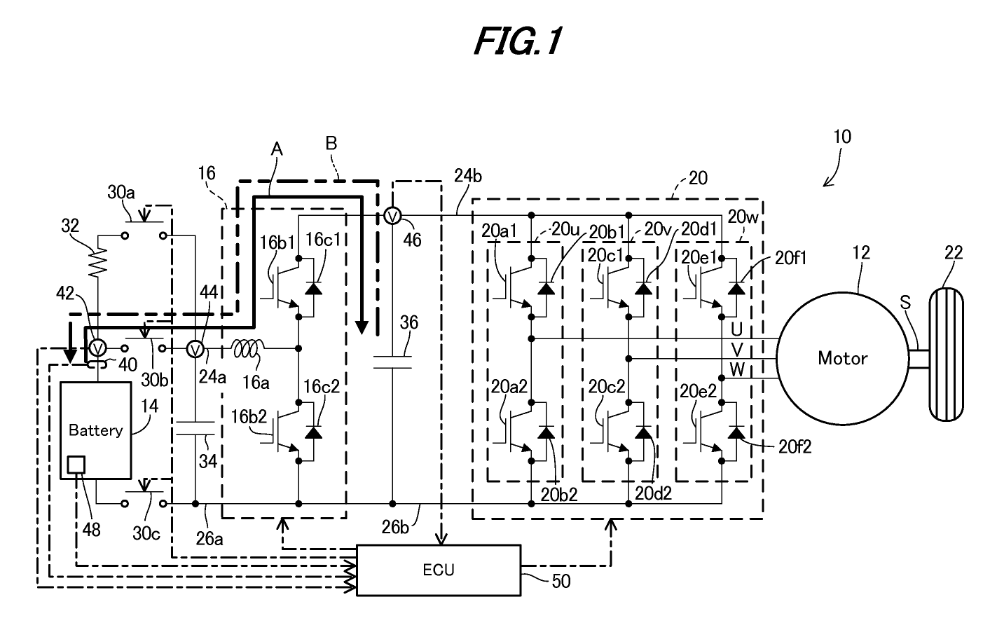

FIG. 1 is an overall view schematically showing a battery heating apparatus for a vehicle according to a first embodiment of this invention.

In FIG. 1, reference numeral 10 designates the vehicle. The vehicle 10 comprises an electric vehicle (EV) equipped with an electric rotating machine (indicated as “Motor” in the FIG. 12, a battery 14 and a buck-boost (step-up/down) converter 16 and inverter 20 that are interposed between the battery 14 and rotating machine 12.

The rotating machine 12 comprises a brushless AC synchronous motor and upon being supplied with current, transfers a rotational output to a wheel (driven wheel) 22 through a connecting shaft S to make the vehicle 10 travel. The rotating machine 12 has a regeneration function to convert kinetic energy generated with rotation of the connecting shaft S into electric energy and output it during deceleration. Specifically, the rotating machine 12 serves as a motor when rotated with the current supply and as a generator when rotated by being driven by the wheel 22, i.e., a motor/generator.

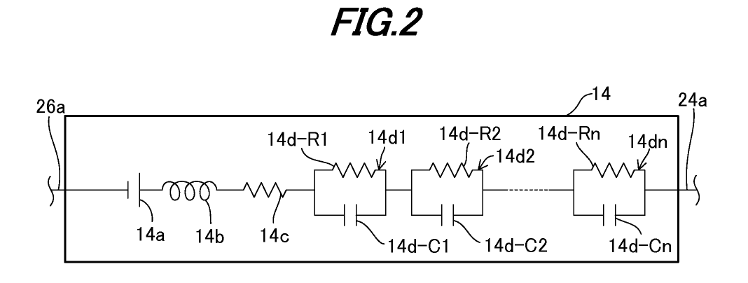

The battery 14 comprises a secondary battery such as a lithium-ion battery. FIG. 2 is a circuit diagram of an equivalent circuit of the battery 14.

As shown in FIG. 2, the battery 14 can be represented using the equivalent circuit in which a DC voltage source 14a indicating an electromotive force, an inductance component 14b of a connection part connecting positive/negative electrode elements with terminals, a resistance component 14c of a collector foil of electrodes, and active materials (positive/negative electrode materials) 14dn (n: 1, 2, 3 . . . ) indicated by parallel circuits, each of which has an electric double layer capacity 14d-Cn and reaction resistance 14d-Rn interconnected in parallel, are connected in series. Thus the battery 14 contains various types of internal resistance.

The explanation on FIG. 1 is resumed. The battery 14 is connected to the converter 16 via a positive electrode wire 24a and negative electrode wire 26a and the converter 16 is connected to the inverter 20 via a positive electrode wire 24b and negative electrode wire 26b. The positive electrode wire 24a is installed with a second contactor (relay) 30b and the negative electrode wire 24b with a third contactor (relay) 30c. The second contactor 30b is connected in parallel with a resistor 32 for precharge function and a first contactor (relay) 30a connected to the resistor 32 in series. The resistor 32 is a current limiting resistor for preventing excessive flow of current from being supplied to a capacitor when the capacitor is precharged (described later).

A first capacitor 34 is interposed between the positive and negative electrode wires 24a, 26a for smoothing direct current outputted from the battery 14 and current similar to rectangular wave current (explained later) generated and outputted from the converter 16. Specifically, the first capacitor 34 is a commonly-used, relatively small capacitor that is not required to store energy and functions as a smoothing filter.

The converter 16 comprises a reactor (inductor) 16a, a plurality of (two) IGBTs (Insulated-Gate Bipolar Transistors; switching elements) 16b1, 16b2 connected to each other in series, and diodes 16c1, 16c2 connected to the IGBTs 16b1, 16b2, respectively, in parallel.

The reactor 16a is connected at its one end with a positive electrode of the battery 14 and at the other end with an emitter terminal (emitter) of the IGBT 16b1 and a collector terminal (collector) of the IGBT 16b2. A collector of the IGBT 16b1 is connected to the positive electrode wire 24b and an emitter of the IGBT 16b2 is connected to the negative electrode wires 26a, 26b. Gate terminals (gates) of the IGBTs 16b1, 16b2 are connected to an electronic control unit (described later) through signal lines.

An anode terminal (anode) of the diode 16c1 is connected to the emitter of the IGBT 16b1 and a cathode terminal (cathode) thereof to the collector thereof. An anode of the diode 16c2 is connected to the emitter of the IGBT 16b2 and a cathode thereof to the collector thereof.

Upon turning ON/OFF the IGBTs 16b1, 16b2, the converter 16 configured as above steps up/down voltage outputted from the battery 14 to be supplied to the rotating machine 12, while stepping up/down voltage generated by the rotating machine 12 to be supplied to the battery 14 to recharge it. Thus the converter 16 comprises a bidirectional buck-boost converter (DC/DC converter).

A second capacitor 36 for smoothing voltage stepped up by the converter 16 is interposed between the positive and negative electrode wires 24b, 26b. The second capacitor 36 also functions as the smoothing filter similarly to the first capacitor 34.

The inverter 20 comprises a three-phase bridge circuit, more precisely, U-phase circuit 20u, V-phase circuit 20v and W-phase circuit 20w. The U-phase circuit 20u is equipped with IGBTs 20a1, 20a2 interposed between the positive and negative electrode wires 24b, 26b, and diodes 20b1, 20b2 connected to the IGBTs 20a1, 20a2 in parallel.

A collector of the IGBT 20a1 is connected to the positive electrode wire 24b and an emitter thereof is connected to a collector of the IGBT 20a2. An emitter of the IGBT 20a2 is connected to the negative electrode wire 26b. An anode of the diode 20b1 is connected to the emitter of the IGBT 20a1 and a cathode thereof to the collector thereof. An anode of the diode 20b2 is connected to the emitter of the IGBT 20a2 and a cathode thereof to the collector thereof.

The V- and W-phase circuits 20v, 20w are configured similarly to the U-phase circuit. Specifically, the V-phase circuit 20v is equipped with IGBTs 20c1, 20c2 and diodes 20d1, 20d2 connected to the IGBTs 20c1, 20c2 in parallel. A collector of the IGBT 20c1 is connected to the positive electrode wire 24b and an emitter thereof is connected to a collector of the IGBT 20c2. An emitter of the IGBT 20c2 is connected to the negative electrode wire 26b. An anode of the diode 20d1 is connected to the emitter of the IGBT 20c1 and a cathode thereof to the collector thereof. An anode of the diode 20d2 is connected to the emitter of the IGBT 20c2 and a cathode thereof to the collector thereof.

The W-phase circuit 20w is equipped with IGBTs 20e1, 20e2 and diodes 20f1, 20f2 connected to the IGBTs 20e1, 20e2 in parallel. A collector of the IGBT 20e1 is connected to the positive electrode wire 24b and an emitter thereof is connected to a collector of the IGBT 20e2. An emitter of the IGBT 20e2 is connected to the negative electrode wire 26b. An anode of the diode 20f1 is connected to the emitter of the IGBT 20e1 and a cathode thereof to the collector thereof. An anode of the diode 20f2 is connected to the emitter of the IGBT 20e2 and a cathode thereof to the collector thereof. Gates of the foregoing six IGBTs 20a1, 20a2, 20c1, 20c2, 20e1, 20e2 are all connected to the electronic control unit through signal lines.

Middle points of the U-, V- and W-phase circuits 20u, 20v, 20w are connected to coils (not shown) of associated phases of the rotating machine 12. Upon turning ON/OFF the IGBTs 20a1, 20a2, 20c1, 20c2, 20e1, 20e2, the inverter 20 configured as above converts direct current stepped up by the converter 16 into three-phase alternating current to be supplied to the rotating machine 12, while converting alternating current generated through the regenerating operation of rotating machine 12 into direct current to be supplied to the converter 16.

A current sensor 40 is connected to the positive electrode wire 24a at a position between the battery 14 and second contactor 30b and produces an output or signal proportional to current Ibat flowing therethrough, i.e., flowing from/to the battery 14.

A voltage sensor 42 is provided at the battery 14 and produces an output or signal proportional to voltage Vbat outputted from the battery 14. The first and second capacitors 34, 36 are also provided with voltage sensors 44, 46 that produce outputs or signals proportional to voltage Vc1 and Vc2 between the terminals of the capacitors 34, 36. Further, a temperature sensor 48 is installed at an appropriate position of the battery 14 to produce an output or signal indicative of a temperature T of the battery 14.

The outputs of the foregoing sensors are sent to the Electronic Control Unit (ECU; now assigned by reference numeral 50) mounted on the vehicle 10. The ECU 50 comprises a microcomputer having a CPU, ROM, RAM and other components.

Based on the inputted outputs, the ECU 50 controls the operation of the converter 16, inverter 20 and contactors 30a, 30b, 30c. Specifically, the ECU 50 controls such that the converter 16 steps up or boosts DC voltage outputted from the battery 14 and the inverter 20 converts the boosted DC voltage into AC voltage to be supplied to the rotating machine 12, while the inverter 20 converts AC voltage generated by the rotating machine 12 into DC voltage and the converter 16 steps up/down the DC voltage to be supplied to the battery 14.

Again the object of this invention will be explained in detail. As described first, when the ambient temperature is relatively low in the winter time or the like, it sometimes causes the decrease in power output of the battery 14 compared to the case of the normal ambient temperature. To cope with it, although the installment of a heater near the battery 14 may be considered, it results in the increase in size of the apparatus or other disadvantages. The object of this invention according to the embodiments is to overcome such the drawback by efficiently heating the battery 14.

The further explanation will be made in the following.

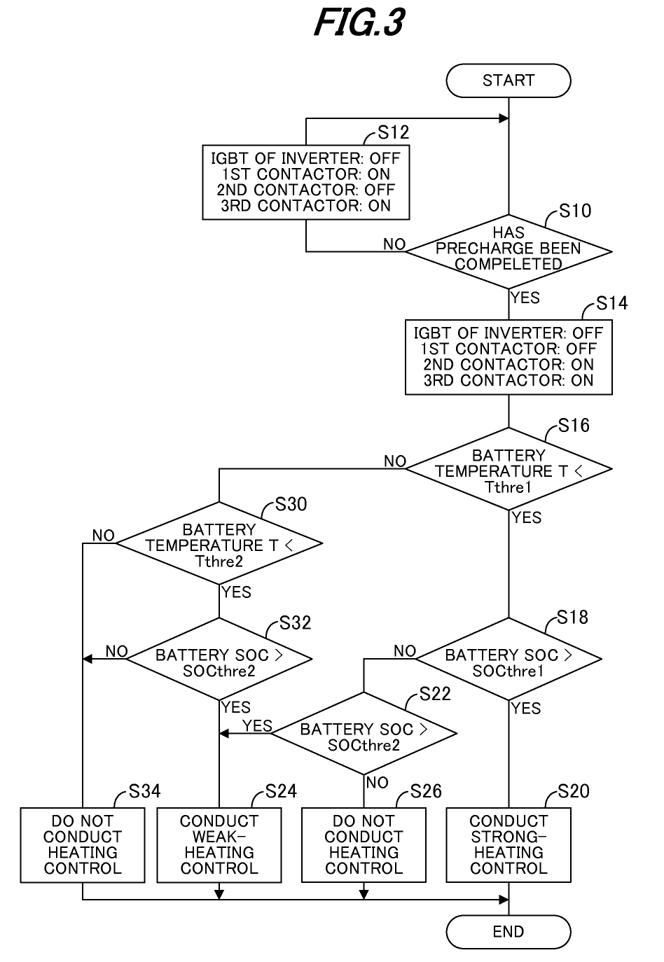

FIG. 3 is a flowchart showing the operation of heating control by the ECU 50. The illustrated program is executed by the ECU 50 at predetermined intervals, e.g., 100 milliseconds, after a starter switch (not shown) of the vehicle is turned on by the operator.

The program begins at S10, in which it is determined whether the precharge of the first capacitor 34 has been completed. This determination is made by comparing a voltage difference between the voltage Vbat of the battery 14 and the voltage Vet of the capacitor 34 with a prescribed value (e.g., 11V) and when the voltage difference is less than the prescribed value, i.e., when the voltage Vc1 is increased to the voltage Vbat or thereabout, the precharge is determined to have been completed.

In the first program loop, since it is before the precharge is applied and the voltage Vc1 is relatively low, the result in S10 is generally negative and the program proceeds to S12. In S12, the six IGBTs of the inverter 20 are all turned OFF and the first and third contactor 30a, 30c are made ON, while the second contactor 30b is made OFF.

As a result, current is flown from the battery 14 to the first capacitor 34 through the resistor 32 so that the precharge is started.

After the process of S12, the program returns to S10. When the result in S10 is affirmative, the program proceeds to S14, in which the IGBTs of the inverter 20 are all turned OFF (more precisely, the OFF state of the IGBTs are maintained), while the first contactor 30a is made OFF and the second and third contactor 30b, 30c are made ON.

Next the program proceeds to S16, in which it is determined whether the temperature T of the battery 14 detected by the temperature sensor 48 is less than a first predetermined temperature (threshold value) Tthre1. The first predetermined temperature Tthre1 is set as a criterion (e.g., −10° C.) for determining that, when the temperature T is less than this value, it is extremely low and, therefore, the battery 14 cannot output the expected power.

When the result in S16 is affirmative, the program proceeds to S18, in which the SOC (State Of Charge) indicating the remaining charge of the battery 14 is detected and it is determined whether the detected SOC is greater than a first predetermined value (threshold value) SOCthre1. The SOC of the battery 14 is detected or calculated based on the voltage Vbat and temperature T of the battery 14, the current Ibat detected by the current sensor 40, and the like. The first predetermined value SOCthre1 is set as a criterion (e.g., 35 percent) for determining whether the SOC of the battery 14 is sufficient for conducting strong-heating control (explained later).

When the result in S18 is affirmative, the program proceeds to S20, in which the operation of the converter 16 is controlled to conduct heating control for heating the battery 14. Specifically, the IGBTs 16b1, 16b2 of the converter 16 are turned ON/OFF to conduct the heating control whose battery heating efficiency is relatively high (hereinafter called the “strong-heating control”).

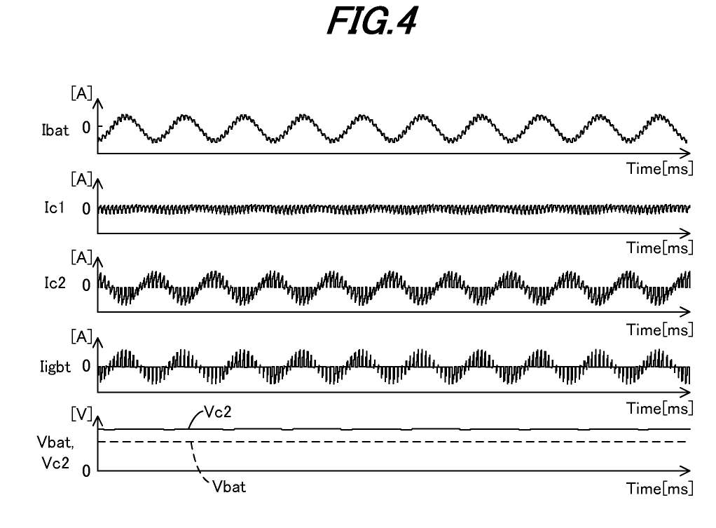

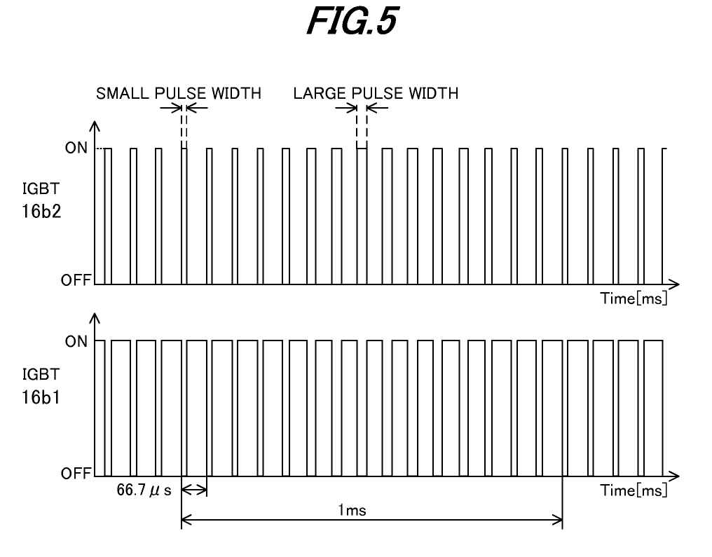

FIG. 4 is a graph showing current flowing through constituent components such as the battery 14 during the strong-heating control and FIG. 5 is a graph showing ON/OFF of the IGBTs 16b1, 16b2 during the strong-heating control. In FIG. 4, there are indicated, in the order from the top, the current Ibat flowing through the battery 14, current Ic1 through the first capacitor 34, current Ic2 through the second capacitor 36, current Iigbt through the IGBT 16b2, and the voltage Vbat of the battery 14 and voltage Vc2 of the second capacitor 36.

The strong-heating control will be explained with reference to FIGS. 1, 4 and 5. First, the IGBT 16b1 of the converter 16 is turned OFF and the IGBT 16b2 is turned ON. At this time, the current is flown from the battery 14 to the second capacitor 36 (i.e., the positive current is flown), as illustrated by a heavy line arrow A in FIG. 1.

On the other hand, when the IGBT 16b1 is turned ON and the IGBT 16b2 is turned OFF, the direction of the current is reversed so that the current is flown from the second capacitor 36 to the battery 14 (i.e., the negative current is flown), as illustrated by a chain double-dashed, heavy line arrow B in FIG. 1.

In the strong-heating control, the ON/OFF operation of the IGBTs 16b1, 16b2 is repeated, i.e., the ON/OFF state thereof is alternately switched as shown in FIG. 5, so that the current similar to rectangular wave current (hereinafter called the “pseudo-AC current”) as shown in FIG. 4 is generated and inputted/outputted between the battery 14 and second capacitor 36 through the first capacitor 34. Note that the term of “current similar to rectangular wave current” or “pseudo-AC current” in the embodiments represents current whose amount and direction (sign) change with respect to the time similarly to rectangular wave current.

Specifically, the pulse widths of the IGBTs 16b1, 16b2 during a time period of ON state (during which the gate voltage is applied) are modulated so that the frequency and amplitude of the current Ibat flowing through the battery 14 exhibit half sine waves of those of the maximum continuous current. In this case, for instance, switching frequency is defined as 15 kHz (cycle: 66.7 μs) and the frequency of a modulation wave as 1 kHz (cycle: 1 millisecond). The upper limit value of the switching frequency is set by detecting the voltage Vbat and Vc2 of destinations (i.e., the battery 14 and second capacitor 36) to which the current is supplied and taking withstand voltage of the battery 14 and second capacitor 36 into consideration.

Through the aforementioned switching operation of the IGBTs 16b1, 16b2, the current Ic2 of the capacitor 36 and the current Iigbt of the IGBT 16b2 exhibit waveforms with inverted phases, so that the current Ibat whose phase is substantially same as that of the current Iigbt is flown through the battery 14. Although ripple current is generated upon the switching operation, since the pseudo-AC current is filtered through the first capacitor (smoothing capacitor) 34, the ripple component of the current Ibat of the battery 14 is decreased.

Further, since the current is flown from the second capacitor 36 to the battery 14, i.e., the stored energy in the capacitor 36 is returned to the battery 14 by turning ON the IGBT 16b1 and OFF the IGBT 16b2, the voltage (output voltage) Vc2 of the capacitor 36 is stepped up compared to the voltage Vbat of the battery 14, and maintained substantially constant.

As mentioned in the foregoing, the operation of the IGBTs 16b1 and 16b2 is controlled such that the pseudo-AC current is inputted/outputted to/from the battery 14 to flow through various types of the internal resistance of the battery 14, whereby the Joule heat is generated and the temperature T is increased accordingly, in other words, the battery 14 is heated up. Consequently, the battery 14 can output the expected voltage.

Here, heat generation of the battery 14 will be explained in detail. Since it is a battery, it can be illustrated using the equivalent circuit with the combination of a connection resistance component (14b) with chemical capacitance (14d-Cn) attributed to electrolyte and a reaction resistance component (14d-Rn) and the like.

The buck-boost converter (bidirectional DC/DC converter) 16 is originally used to transform DC voltage to DC voltage. However, in the heating control according to the embodiments, in the case where the rotating machine 12 and inverter 20 are not in operation, the converter 16 is applied to generate AC voltage such as power supply voltage. The pseudo-AC current outputted from the converter 16 has a waveform made by superimposing a switching ripple current waveform on a modulation waveform made by superimposing sine waves of various orders.

Therefore, a low frequency component of the modulation waveform is flown to the chemical capacitance attributed to chemical reaction of the battery 14 and it prompts the reaction resistance to generate heat, while a high frequency component of the modulation waveform and a ripple current frequency component caused by the switching operation prompt the connection resistance to generate heat. Thus, due to use of the modulation wave, the resistance components existing in a variety of positions on the equivalent circuit of the battery 14 can function as heat sources.

The explanation on FIG. 3 is resumed. When the result in S18 is negative, the program proceeds to S22, in which it is determined whether the SOC of the battery 14 is greater than a second predetermined value (threshold value) SOCthre2. The second predetermined value SOCthre2 is set smaller than the first predetermined value SOCthre1, as a criterion (e.g., 25 percent) for determining whether the SOC of the battery 14 is sufficient for conducting weak-heating control (explained later).

When the result in S22 is affirmative, the program proceeds to S24, in which the operation of the converter 16 is controlled to conduct the heating control for heating the battery 14. Specifically, the IGBTs 16b1, 16b2 of the converter 16 are turned ON/OFF to conduct the heating control whose battery heating efficiency is weaker or lower than the strong-heating control (hereinafter called the “weak-heating control”).

The ON/OFF operation of the IGBTs 16b1, 16b2 of the weak-heating control is basically the same as that of the strong-heating control. Specifically, the IGBTs 16b1, 16b2 are turned ON/OFF to generate the pseudo-AC current to be inputted or outputted between the battery 14 and the second capacitor 36.

However, the switching control is conducted so that the frequency and amplitude of the current Ibat flown through the battery 14 are smaller than those in the strong-heating control, more precisely, exhibit one-fourth sine waves of those of the maximum continuous current. As a result, in the weak-heating control, although it is lower in the heating efficiency than the strong-heating control, power of the battery 14 to be used for heating can be decreased.

Thus the frequency and amplitude of the current Ibat flown through the battery 14 can be adjusted (selected) and based on the SOC and temperature T of the battery 14, they are selected to conduct the strong or weak-heating control.

When the result in S22 is negative, i.e., when the SOC of the battery 14 is low, the program proceeds to S26, in which the program is terminated without conducting any of the strong-heating control and weak-heating control.

When the result in S16 is negative, the program proceeds to S30, in which it is determined whether the temperature T of the battery 14 is less than a second predetermined temperature (threshold value) Tthre2. The second predetermined temperature Tthre2 is set higher than the first predetermined temperature Tthre1, as a criterion value (e.g., 5° C.) for determining that, when the temperature T is less than this value, the battery 14 may not output the expected power because the battery temperature is low.

When the result in S30 is negative, since it means that the battery 14 can output the expected power and is not necessary to be heated up, the program proceeds to S34, in which the heating control is not conducted or, when already in implementation, is stopped, whereafter the program is terminated.

In contrast, when the result in S30 is affirmative, the program proceeds to S32, in which, similarly to S22, it is determined whether the SOC of the battery 14 is greater than the second predetermined value SOCthre2. When the result in S32 is affirmative, the program proceeds to S24, in which the weak-heating control is conducted (when the strong-heating control is in implementation, it is switched to the weak-heating control). When the result in S32 is negative, the program proceeds to S34, in which the program is terminated without conducting any heating control.

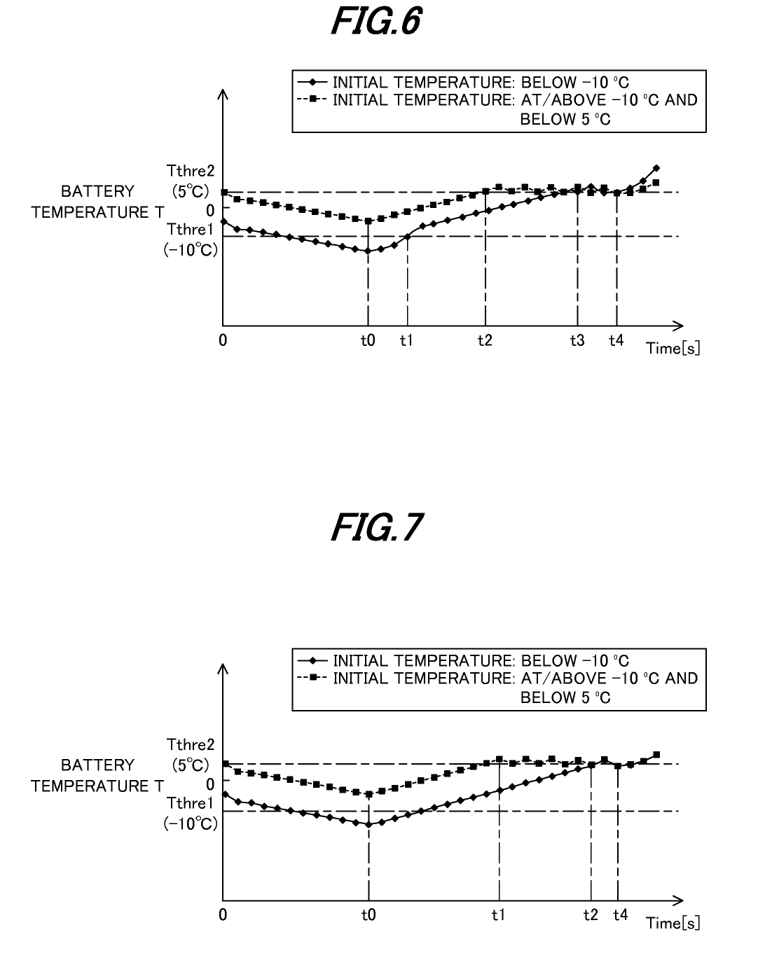

FIGS. 6 and 7 are data tables of results of simulation for evaluating transition of the battery temperature T in the heating control shown in FIG. 3.

FIG. 6 is for the transition of the temperature T when the SOC of the battery 14 is above the first predetermined value SOCthre1 and FIG. 7 is for that when the SOC is above the second predetermined value SOCthre2 and at or below the first predetermined value SOCthre1. Also, in FIGS. 6 and 7, a case where the initial temperature (precisely, the temperature at the time the starter switch of the vehicle 10 is turned on) is below the first predetermined temperature Tthre1 is indicated by solid lines, while a case where it is at or above the first predetermined temperature Tthre1 and below the second predetermined temperature Tthre2 is indicated by dashed lines.

First the explanation is made with reference to FIG. 6. At the time t0, the starter switch of the vehicle 10 is turned on and when the temperature T of the battery 14 is less than the first predetermined temperature Tthre1 at that time (affirmative result in S16), the strong-heating control is conducted (S20). As a result, the temperature T is sharply increased.

When, at the time t1, the temperature T reaches the predetermined temperature Tthre1 (negative result in S16), the weak-heating control is conducted (S24), so that the temperature T is slowly increased continuously. After that, when, at the time t3, the temperature T reaches the second predetermined temperature Tthre2 (negative result in S30), the weak-heating control is stopped (S34). When it is assumed that the vehicle 10 is started to travel (run) at the time t4, the weak-heating control is conducted intermittently until that time.

When, at the time t0, the temperature T is equal to or greater than the first predetermined temperature Tthre1 and less than the second predetermined temperature Tthre2 (negative result S16, affirmative result in S30) the weak-heating control is conducted (S24). As a result, the temperature T is gradually increased as indicated by the dashed line in FIG. 6. When, at the time t2, the temperature T reaches the predetermined temperature Tthre2 (negative result in S30), the weak-heating control is stopped (S34). After that, the weak-heating control is conducted intermittently until the time t4, as mentioned above.

In FIG. 7, since the SOC is greater than the second predetermined value SOCthre2 and equal to or less than the first predetermined value SOCthre1, the strong-heating control is not conducted regardless of degree of the initial temperature and after the time t0, the weak-heating control is immediately started (S24).

Then the temperature T reaches the second predetermined temperature Tthre2 at the time t1 in the case where the initial temperature is at or above the predetermined temperature Tthre1 and below the predetermined temperature Tthre2 (indicated by the dashed line) or at the time t2 in the case where the initial temperature is less than the predetermined temperature Tthre1 (indicated by the solid line) (negative result in S30), and the weak-heating control is stopped (S34). After that, the weak-heating control is conducted intermittently until the time t4, similarly to the case of FIG. 6.

Thus, the first embodiment is configured to have the first capacitor 34 interposed between the positive electrode wire 24a and negative electrode wire 26a, the wires 24a, 26a connecting the battery 14 to the converter 16, the second capacitor 36 interposed between the positive electrode wire 24b and negative electrode wire 26b, the wires 24b, 26b connecting the converter 16 to the rotating machine 12, and operation of the converter is controlled to generate current similar to rectangular wave current (pseudo-AC current) and input/output the current between the battery 14 and the second capacitor 36 through the first capacitor 34 so as to heat the battery 14.

With this, it becomes possible to efficiently heat the battery 14 through heat generation of the internal resistance even when the ambient temperature is relatively low in the winter time or the like, so that the battery 14 can output the expected power without adversely affecting the size of the apparatus because the installment of a heater or the increase in capacitance of a capacitor are not required. As a result, it can shorten a time period since the vehicle 10 is started until the vehicle operation performance at the normal battery temperature is ensured.

In the apparatus, the converter 16 comprises the IGBTs (switching elements) 16b1, 16b2 and the heating control is conducted to heat the battery 14 by turning ON/OFF the IGBTs 16b1, 16b2. With this, it becomes possible to reliably conduct the heating control with simple structure.

In the apparatus, the vehicle 10 comprises an electric vehicle. With this, the battery 14 installed in the electric vehicle can be efficiently heated up.

In the apparatus, it is configured to detect remaining charge (SOC) of the battery 14, and the current similar to rectangular wave current is generated in accordance with the detected remaining charge. With this, it becomes possible to change the frequency and amplitude of the pseudo-AC current depending on the detected remaining charge (SOC) of the battery 14, thereby conducting the optimal heating control based on the battery 14 condition.

In the apparatus, it is configured to detect the temperature T of the battery 14, and the current similar to rectangular wave current is generated in accordance with the detected temperature T. With this, it becomes possible to change the frequency and amplitude of the pseudo-AC current depending on the battery temperature T, thereby conducting the optimal heating control based on the battery 14 condition.

A battery heating apparatus for a vehicle according to a second embodiment of the invention will be explained.

In the second embodiment, the frequency and amplitude of the pseudo-AC current are determined by retrieving the characteristics (mapped data) set beforehand.

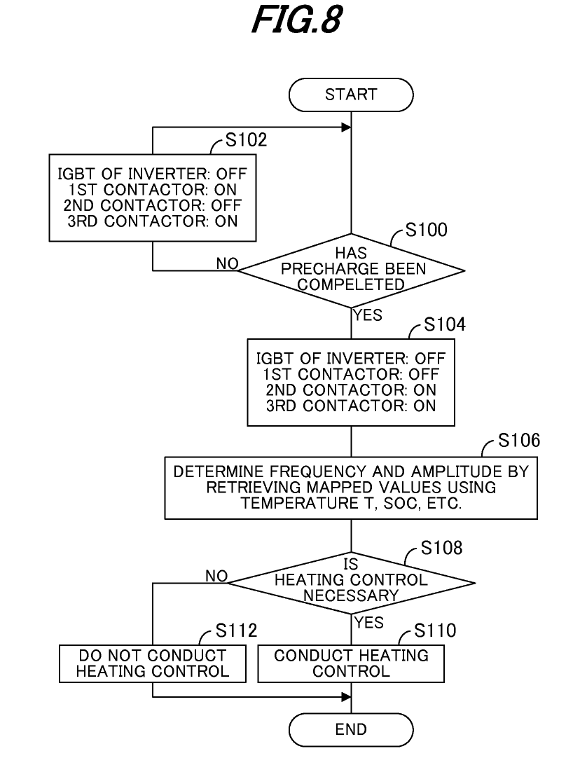

FIG. 8 is a flowchart similar to FIG. 3, but showing the operation of heating control by the ECU 50 of the apparatus according to the second embodiment.

As shown in FIG. 8, the steps of S100 to S104 are processed similarly to those of S10 to S14 in the first embodiment. Then the program proceeds to S106, in which the frequency and amplitude of the current Ibat flown through the battery 14 are determined by retrieving the mapped values using the temperature T, SOC, battery capacitance and internal resistance of the battery 14 (including gains used for controlling the level (strong/weak) of the heating control in accordance with the battery capacitance and internal resistance (i.e., the condition (degradation condition) of the battery 14)).

The map data, i.e., characteristics are appropriately defined so that the frequency and amplitude are increased with decreasing temperature T of the battery 14, in other words, so as to achieve the high heating efficiency, and so that the frequency and amplitude are increased with increasing SOC.

Then the program proceeds to S108, in which it is determined whether it is necessary to heat the battery 14. Heating is determined to be necessary when, for example, the battery 14 is in a condition where it can not output expected power due to the low temperature and the SOC is sufficient for conducting the heating control, while being determined to be unnecessary (or inappropriate) when the temperature T is relatively high or the SOC is relatively low.

When the result in S108 is affirmative, the program proceeds to S110, in which the operation of the converter 16 is controlled to conduct the heating control. Specifically, the IGBTs 16b1, 16b2 of the converter 16 are turned ON/OFF to generate the pseudo-AC current having the frequency and amplitude determined in S106 and this current is inputted/outputted to/from the battery 14. As a result, the current is flown through the internal resistance of the battery 14 so that the internal resistance generates heat, thereby increasing the temperature T of the battery 14, i.e., heating the battery 14.

On the other hand, when the result in S108 is negative, the program proceeds to S112, in which the heating control is not conducted or when already in implementation, is stopped, whereafter the program is terminated.

Thus the second embodiment is configured to generate the current similar to rectangular wave current (pseudo-AC current) in accordance with the detected remaining charge (SOC) based on the characteristics set beforehand. With this, it becomes possible to change the frequency and amplitude of the pseudo-AC current Ibat depending on the SOC of the battery 14 based on the characteristics set beforehand, thereby conducting the heating control suitable for the battery 14 condition.

In the apparatus, it is configured to generate the current similar to rectangular wave current (pseudo-AC current) in accordance with the detected temperature T based on the characteristics set beforehand. With this, it becomes possible to change the frequency and amplitude of the pseudo-AC current Ibat depending on the temperature T based on the characteristics set beforehand, thereby conducting the heating control suitable for the battery 14 condition.

Further, since the pseudo-AC current is generated in accordance with the battery capacitance and internal resistance based on the characteristics set beforehand, it becomes possible to change the frequency and amplitude of the pseudo-AC current Ibat depending on battery capacitance and internal resistance based on the characteristics set beforehand, thereby conducting the heating control suitable for the battery 14 condition.

The remaining configuration is the same as that in the first embodiment.

As stated above, the first and second embodiments are configured to have an apparatus for heating a battery 14 of a vehicle 10, having an electric rotating machine (motor/generator) 12 installed in the vehicle 10 and a buck-boost converter 16 interposed between the battery 14 and the rotating machine 12 and adapted to step up/down voltage outputted from the battery 14 to be supplied to the rotating machine 12 and step up/down voltage generated by the rotating machine 12 to be supplied to the battery 14, comprising: a first capacitor 34 interposed between a positive electrode wire 24a and a negative electrode wire 26a, the wires 24a, 26a connecting the battery 14 to the converter 16; a second capacitor 36 interposed between a positive electrode wire 24b and a negative electrode wire 26b, the wires 24b, 26b connecting the converter 16 to the rotating machine 12; and a heating controller (ECU 50, S16 to S34, S106 to S112) adapted to control operation of the converter 16 to generate current similar to rectangular wave current (pseudo-AC current) and input/output the current between the battery 14 and the second capacitor 36 through the first capacitor 34 so as to heat the battery 14 (i.e., conduct the strong-heating control or weak-heating control).

In the apparatus, the converter 16 comprises switching elements (IGBTs) 16b1, 16b2 and the heating controller heats the battery 14 by turning ON/OFF the switching elements 16b1, 16b2 (S20, S24, S110).

In the apparatus, the vehicle 10 comprises an electric vehicle.

The apparatus further includes a remaining charge detector (current sensor 40, voltage sensor 42, temperature sensor 48, ECU 50) adapted to detect remaining charge (SOC) of the battery 14, and the heating controller is operated to generate the current similar to rectangular wave current in accordance with the detected remaining charge (SOC) (S18 to S26, S32, S34, S106 to S112).

In the second embodiment, the apparatus further includes a remaining charge detector (current sensor 40, voltage sensor 42, temperature sensor 48, ECU 50) adapted to detect remaining charge (SOC) of the battery 14, and the heating controller is operated to generate the current similar to rectangular wave current in accordance with the detected remaining charge (SOC) based on characteristics set beforehand (S106 to S112).

In the first and second embodiments, the apparatus further includes a temperature detector (temperature sensor 48) adapted to detect a temperature T of the battery 14, and the heating controller is operated to generate the current similar to rectangular wave current in accordance with the detected temperature T (S16, S20, S24, S26, S30, S34, S106 to S112).

In the second embodiment, the apparatus further includes a temperature detector (temperature sensor 48) adapted to detect a temperature T of the battery 14, and the heating controller is operated to generate the current similar to rectangular wave current in accordance with the detected temperature T based on characteristics set beforehand (S106 to S112).

It should be noted that, although the electric vehicle 10 is exemplified in the foregoing, this invention can be applied to a hybrid vehicle (equipped with an internal combustion engine and an electric rotating machine (motor) as prime movers; HEV) and fuel cell (FC) vehicle.

It should also be noted that, although the secondary battery comprising the lithium-ion battery is taken as an example of the battery 14, it may instead be a lead battery, nickel-hydrogen battery, etc., and a capacitor may be utilized, too.

It should also be noted that, although the first and second predetermined temperature Tthre1, Tthre2, first and second predetermined value SOCthre1, SOCthre2, frequency and amplitude of the current, and other values are indicated with specific values in the foregoing, they are only examples and not limited thereto.

Japanese Patent Application No. 2010-128540, filed on Jun. 4, 2010 is incorporated by reference herein in its entirety.

While the invention has thus been shown and described with reference to specific embodiments, it should be noted that the invention is in no way limited to the details of the described arrangements; changes and modifications may be made without departing from the scope of the appended claims.

What is claimed is:

1. An apparatus for heating a battery of a vehicle, having an electric rotating machine installed in the vehicle and a buck-boost converter interposed between the battery and the rotating machine and adapted to step up/down voltage outputted from the battery to be supplied to the rotating machine and step up/down voltage generated by the rotating machine to be supplied to the battery, comprising:
a first capacitor interposed between a positive electrode wire and a negative electrode wire, the wires connecting the battery to the converter;
a second capacitor interposed between a positive electrode wire and a negative electrode wire, the wires connecting the converter to the rotating machine; and
a heating controller adapted to control operation of the converter to generate current similar to rectangular wave current and input/output the current between the battery and the second capacitor through the first capacitor so as to heat the battery.

2. The apparatus according to claim 1, wherein the converter comprises switching elements and the heating controller heats the battery by turning ON/OFF the switching elements.

3. The apparatus according to claim 1, wherein the vehicle comprises an electric vehicle.

4. The apparatus according to claim 1, further including:
a remaining charge detector adapted to detect remaining charge of the battery,
and the heating controller is operated to generate the current similar to rectangular wave current in accordance with the detected remaining charge.

5. The apparatus according to claim 1, further including:
a remaining charge detector adapted to detect remaining charge of the battery,
and the heating controller is operated to generate the current similar to rectangular wave current in accordance with the detected remaining charge based on characteristics set beforehand.

6. The apparatus according to claim 1, further including:
a temperature detector adapted to detect a temperature of the battery,
and the heating controller is operated to generate the current similar to rectangular wave current in accordance with the detected temperature.

7. The apparatus according to claim 1, further including:
a temperature detector adapted to detect a temperature of the battery,
and the heating controller is operated to generate the current similar to rectangular wave current in accordance with the detected temperature based on characteristics set beforehand.
